(19) United States
(12) Patent Application Publication
(10) Pub. No.: US 2026/0197689 A1
(43) Pub. Date: Jul. 9, 2026

(54) REDUCED CELL ACTIVATION DELAY

(71) Applicant: Nokia Technologies Oy, Espoo (FI)

(72) Inventors: Lei DU, Beijing (CN); Lars DALSGAARD, Oulu (FI); Daejung YOON, Nozay (FR)

(21) Appl. No.: 18/995,017

(22) PCT Filed: Aug. 10, 2022
(86) PCT No.: PCT/CN2022/111515

§ 371 Date: Jan. 15, 2025

(30) Foreign Application Priority Data
Aug. 10, 2022 (WO) PCT/CN2022/111515

(51) Int. Cl. H04W 24/10; H04B 7/06

(52) U.S. Cl. CPC H04W 24/10; H04B 7/0626

(57) ABSTRACT

Example embodiments of the present disclosure relate to a terminal device, a network device, methods, apparatuses and a computer readable storage medium for reducing cell activation delay. A terminal device determines, during an activation procedure of a secondary cell, at least one measurement result of the secondary cell at the terminal device, and performs a layer 1 measurement on the secondary cell based, at least partially, on the at least one measurement result. As such, there is no need to perform the layer 1 measurement on full beams and the time length of the activation procedure may be shorter. Thus, the activation delay can be reduced, the power consumption can be reduced, and the communication efficiency may be improved.

### FIELD

Example embodiments of the present disclosure generally relate to the field of telecommunication and in particular, to a terminal device, a network device, methods, apparatuses and a computer readable storage medium for a solution of reducing cell activation delay.

### BACKGROUND

In a communication system, such as New Radio (NR) and Long Term Evolution (LTE), a secondary cell (SCell) can be activated or deactivated to enable reasonable User Equipment (UE) battery consumption when Carrier Aggregation (CA) is configured. The transition between an activated state and a deactivated state may be based on Media Access Control (MAC) Control Element (CE) commands from a network device. For example, an activation command from the network device may indicate to activate the SCell.

It takes activation time, i.e., activation delay, for the UE to transition from the deactivated state to the activated state. In some conditions, the activation delay could become very long. How to reduce the activation delay needs to be further studied and developed.

### SUMMARY

In general, example embodiments of the present disclosure provide a solution for reducing cell activation delay.

In a first aspect, there is provided a terminal device. The terminal device comprises at least one processor and at least one memory storing instructions that, when executed by the at least one processor, cause the terminal device at least to: determine, during an activation procedure of a secondary cell, at least one measurement result of the secondary cell at the terminal device; and perform a layer 1 measurement on the secondary cell based, at least partially, on the at least one measurement result.

In a second aspect, there is provided a network device. The network device comprises at least one processor and at least one memory storing instructions that, when executed by the at least one processor, cause the network device at least to: transmit, to a terminal device in a primary cell, an activation command indicating a permission that the terminal device is allowed to perform a fast layer 1 measurement during an activation procedure of a secondary cell; and receive, from the terminal device, a measurement report indicating whether a layer 1 measurement performed at the terminal device is the fast layer 1 measurement.

In a third aspect, there is provided a method performed by a terminal device. The method comprises: determining, at a terminal device during an activation procedure of a secondary cell, at least one measurement result of the secondary cell at the terminal device; and performing a layer 1 measurement on the secondary cell based, at least partially, on the at least one measurement result.

In a fourth aspect, there is provided a method performed by a network device. The method comprises: transmitting, at a network device to a terminal device in a primary cell, an activation command indicating a permission that the terminal device is allowed to perform a fast layer 1 measurement during an activation procedure of a secondary cell; and receiving, from the terminal device, a measurement report indicating whether a layer 1 measurement performed at the terminal device is the fast layer 1 measurement.

In a fifth aspect, there is provided an apparatus. The apparatus comprises: means for determining, at a terminal device during an activation procedure of a secondary cell, at least one measurement result of the secondary cell at the terminal device; and means for performing a layer 1 measurement on the secondary cell based, at least partially, on the at least one measurement result.

In a sixth aspect, there is provided an apparatus. The apparatus comprises: means for transmitting, at a network device to a terminal device in a primary cell, an activation command indicating a permission that the terminal device is allowed to perform a fast layer 1 measurement during an activation procedure of a secondary cell; and means for receiving, from the terminal device, a measurement report indicating whether a layer 1 measurement performed at the terminal device is the fast layer 1 measurement.

In a seventh aspect, there is provided a non-transitory computer readable medium comprising program instructions for causing an apparatus to perform at least the method in the third or fourth aspect.

In an eighth aspect, there is provided a computer program comprising instructions, which, when executed by an apparatus, cause the apparatus at least to perform the method in the third or fourth aspect.

In a ninth aspect, there is provided a terminal device. The terminal device comprises: determining circuitry configured to determine, at a terminal device during an activation procedure of a secondary cell, at least one measurement result of the secondary cell at the terminal device; and performing circuitry configured to perform a layer 1 measurement on the secondary cell based, at least partially, on the at least one measurement result.

In a tenth aspect, there is provided a network device. The network device comprises: transmitting circuitry configured to transmit, at a network device to a terminal device in a primary cell, an activation command indicating a permission that the terminal device is allowed to perform a fast layer 1 measurement during an activation procedure of a secondary cell; and receiving circuitry configured to receive, from the terminal device, a measurement report indicating whether a layer 1 measurement performed at the terminal device is the fast layer 1 measurement.

In an eleventh aspect, there is provided a computer readable medium comprising program instructions that, when executed by an apparatus, cause the apparatus to perform at least the method in the third or fourth aspect.

In a twelfth aspect, there is provided an apparatus comprising means for performing: determining, during an activation procedure of a secondary cell, at least one measurement result of the secondary cell at the terminal device; and performing a layer 1 measurement on the secondary cell based, at least partially, on the at least one measurement result.

In a thirteenth aspect, there is provided an apparatus comprising means for performing: transmitting, to a terminal device in a primary cell, an activation command indicating a permission that the terminal device is allowed to perform a fast layer 1 measurement during an activation procedure of a secondary cell; and receiving, from the terminal device, a measurement report indicating whether a layer 1 measurement performed at the terminal device is the fast layer 1 measurement.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example of SCell activation when activating an FR2 unknown SCell;

FIG. 2 illustrates an example of a network environment in which some example embodiments of the present disclosure may be implemented;

FIG. 3 illustrates an example of a process flow in accordance with some example embodiments of the present disclosure;

FIG. 4A illustrates an example process where the terminal device has layer 3 measurement results for FR2 unknown SCell in accordance with some example embodiments of the present disclosure;

FIG. 4B illustrates an example process where the terminal device does not have a layer 3 measurement result for FR2 unknown SCell in accordance with some example embodiments of the present disclosure;

FIG. 5 illustrates a flowchart of a method implemented at a terminal device in accordance with some example embodiments of the present disclosure;

FIG. 6 illustrates a flowchart of a method implemented at a network device in accordance with some example embodiments of the present disclosure;

FIG. 7 illustrates a simplified block diagram of a device that is suitable for implementing some example embodiments of the present disclosure; and

FIG. 8 illustrates a block diagram of an example of a computer readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a new radio (NR) NB (also referred to as a gNB), a Remote Radio Unit (RRU), a radio header (RH), a remote radio head (RRH), an integrated access and backhaul (IAB) node, a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a machine type communication (MTC) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As discussed above, an SCell is configured to be in the deactivated state to enable reasonable UE battery consumption when CA is configured. It takes time, i.e. activation delay, to transition from the deactivated status to the activated status, which is composed of multiple parts including T_{activation_time}. In some conditions e.g. unknown target SCell, the activation delay could become very long due to cell detection, beam measurement e.g. layer 1 reference signal received power (L1-RSRP) measurement and channel state information (CSI) measurement etc. The term “layer 1 (L1)” in the present disclosure may refer to a physical layer, which may be abbreviated as PHY.

The delay requirements T_{activation_time} which indicates the delay within which the UE shall be able to activate the deactivated SCell is defined. The delay requirements are based on the SCell conditions at the reception of the activation command and during the activation time including:
if the SCell is known or unknown,
if the SCell belongs to frequency range 1 (FR1) or FR2,
if there is already a serving cell on the same FR2 band or not,
if periodic or semi-persistent channel-state information reference signal (CSI-RS)
is used for CSI reporting etc.
   The reasoning behind is that UE takes different activation steps under these different conditions.

In the context of the present disclosure, an SCell is “known” means the UE has sent L3 measurement report within a certain time period prior to receiving the activation command, and the reported synchronization signal block (SSB) indexes remains detectable during SCell activation period.

```
For the first SCell activation in FR2 bands, the SCell is known if it has been meeting the
following conditions:
  - During the period equal to 4s for UE supporting power class 1/5 and 3s for UE
  supporting power class 2/3/4 before UE receives the last activation command for
  PDCCH TCI, PDSCH TCI (when applicable) and semi-persistent CSI-RS for CQI
  reporting (when applicable):
  - the UE has sent a valid L3-RSRP measurement report with SSB index
  - SCell activation command is received after L3-RSRP reporting and no later than
  the time when UE receives MAC-CE command for TCI activation
  - During the period from L3-RSRP reporting to the valid CQI reporting, the reported
  SSBs with indexes remain detectable according to the cell identification conditions
  specified in clauses 9.2 and 9.3, and the TCI state is selected based on one of the latest
  reported SSB indexes.
Otherwise, the first SCell in FR2 band is unknown.
```

In the context of the present disclosure, the terms SCell activation delay, SCell activation delay requirements, activation delay, activation delay requirements, delay, delay requirements or the like may be used interchangeable.

T_{activation_time} may be based on whether there is already a serving cell on the same FR2 band. For instance, if there is a serving cell on the FR2 band, the UE can reuse the beam information acquired in serving cell to the SCell to be activated (i.e. target SCell), hence very short time T_{FirstSSB}+5 ms is needed to activate the SCell. However, if the target SCell is the first SCell on the band, the UE would have to wait for the network command, e.g., transmission configuration indicator (TCI) activation, to indicate the downlink (DL) beams, where the TCI indication relies on the latest UE measurement report received by the network.

T_{activation_time} may be based on whether the SCell is known or unknown. For instance, if the SCell is known in FR2, the network determines the TCI based on L3 measurement report received before transmitting the activation command, so only the MAC uncertainty time is considered in SCell activation delay.

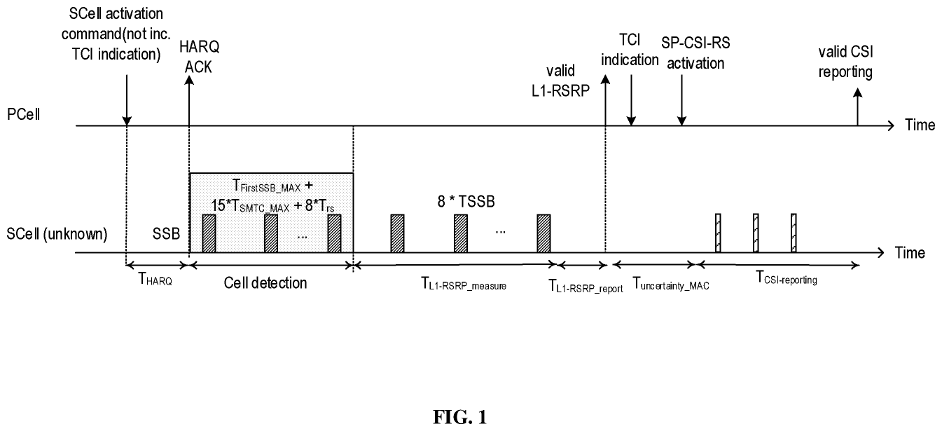

However, if the SCell is unknown in FR2, as shown in FIG. 1, the UE is expected to firstly detect the cell including DL synchronization, automatic gain control (AGC) and time/frequency fine tuning, which takes long time: T_{FirstSSB_MAX}+15*T_{SMTC_MAX}+8*Tᵣₛ. Then additional L1-RSRP measurement and reporting, i.e. T_{L1-RSRP, measure} and T_{L1-RSRP, report} are needed to acquire the beam information and report to network. The activation delay for FR2 unknown SCell is specified as below by combining FIG. 1:

```
If the PCell/PSCell and the target SCell are configured as FR1-FR2 CA or if the
PCell/PSCell and the target SCell are in a FR2 band pair with independent beam
management, and the target SCell is unknown to UE and semi-persistent CSI-RS is used for
CSI reporting, provided that the side condition Ês/lot ≥ −2dB is fulfilled, then T_{activation}_{_{—}}ₜᵢₘₑ
is:
  - 6ms + T_{FirstSSB}_{_{—}}_{MAX} + 15*T_{SMTC}_{_{—}}_{MAX} + 8*Tᵣₛ + T_{L1-RSRP, measure} + T_{L1-RSRP, report} +
  T_{HARQ} + max(T_{uncertainty}_{_{—}}_{MAC} + T_{FineTiming} + 2ms, T_{uncertainty}_{_{—}}_{SP}).
If the PCell/PSCell and the target SCell are configured as FRI-FR2 CA or if the
PCell/PSCell and the target SCell are in a FR2 band pair with independent beam
management, and the target SCell is unknown to UE and periodic CSI-RS is used for CSI
reporting, provided that the side condition Ês/Iot ≥ −2dB is fulfilled, then T_{activation}_{_{—}}ₜᵢₘₑ is:
  - 3ms + T_{FirstSSB}_{_{—}}_{MAX} + 15*T_{SMTC}_{_{—}}_{MAX} + 8*Tᵣₛ + T_{L1-RSRP, measure} + T_{L1-RSRP, report} + max
  {(T_{HARQ} + T_{uncertainty}_{_{—}}_{MAC} + 5ms + T_{FineTiming}), (T_{uncertainty}_{_{—}}_{RRC} + T_{RRC}_{_{—}}_{delay})}.
```

Similarly, L1-RSRP measurement is also needed in FR1 if the SCell is unknown and non-contiguous to an active cell in the same band:

```
otherwise, provided that the side condition Ês/Iot ≥ −2dB is fulfilled, T_{activation}_{_{—}}ₜᵢₘₑ is:
  - 6ms + T_{FirstSSB}_{_{—}}_{MAX} + T_{SMTC}_{_{—}}_{MAX} + Tᵣₛ + T_{L1-RSRP,measure} + T_{L1-RSRP,report} + T_{HARQ} +
  max(T_{uncertainty}_{_{—}}_{MAC} + T_{FineTiming} + 2ms, T_{uncertainty}_{_{—}}_{SP}), if semi-persistent CSI-RS is used
  for CSI reporting,
  - 3ms + T_{FirstSSB}_{_{—}}_{MAX} + T_{SMTC}_{_{—}}_{MAX} + Tᵣₛ + T_{L1-RSRP,measure} + T_{L1-RSRP,report} + max(T_{HARQ}
  + T_{uncertainty}_{_{—}}_{MAC} + 5ms + T_{FineTiming}, T_{uncertainty}_{_{—}}_{RRC} + T_{RRC}_{_{—}}_{delay}), if periodic CSI-RS is
  used for CSI reporting.
```

With respect to the above mentioned parameters, their meanings are described below:

In the FR1, in the case of intra-band SCell activation, T_{SMTC_MAX} represents the longer SSB-based RRM measurement timing configuration (SMTC) periodicity between active serving cells and SCell being activated provided the cell-specific reference signals from the active serving cells and the SCells being activated or released are available in the same slot; in case of inter-band SCell activation, T_{SMTC_MAX} represents the SMTC periodicity of SCell being activated; in the FR2, T_{SMTC_MAX} represents the longer SMTC periodicity between active serving cells and SCell being activated provided that in Rel-15 only support FR2 intra-band CA. T_{SMTC_MAX} can be bounded to a minimum value of 10 ms.
Tᵣₛ represents the SMTC periodicity of the SCell being activated if the UE has been provided with an SMTC configuration for the SCell in the SCell addition message, otherwise, Tᵣₛ represents the SMTC configured in the measObjectNR having the same SSB frequency and subcarrier spacing; if the UE is not provided SMTC configuration or measurement object on this frequency, the requirement which involves Tᵣₛ is applied with Tᵣₛ=5 ms assuming the SSB transmission periodicity is 5 ms; there are no requirements if the SSB transmission periodicity is not 5 ms.
T_{FirstSSB}_MAX represents the time to the end of the first complete SSB burst indicated by the SMTC after slot

$$n + \frac{{T}_{HARQ} + 3 ms}{NR slot length} ,$$

further fulfilling:
   In the FR1, in the case of intra-band SCell activation, the occasion when all active serving cells and SCells being activated or released are transmitting SSB bursts in the same slot; in the case of inter-band SCell activation, the first occasion when the SCell being activated is transmitting SSB burst.
   In the FR2, the occasion when all active serving cells and SCells being activated or released are transmitting SSB bursts in the same slot.
T_{FineTiming} represents the time period between UE finishes processing the last activation command for PDCCH transmission configuration indicator (TCI), physical downlink shared channel (PDSCH) TCI (when applicable) and the timing of first complete available SSB corresponding to the TCI state.
T_{L1-RSRP, measure} represents L1-RSRP measurement delay T_{L1-RSRP_Measurement_Period_SSB} ms or T_{L1-RSRP_Measurement_Period_CSI-RS} based on applicability as defined in clause 9.5 assuming M=1.
T_{L1-RSRP, report} represents the delay of acquiring CSI reporting resources.
T_{uncertainty_MAC} represents the time period between reception of the last activation command for PDCCH TCI, PDSCH TCI (when applicable) relative to SCell activation command for known case; First valid L1-RSRP reporting for the unknown case.
T_{uncertainty_RRC} represents the time period between reception of the RRC configuration message for TCI of periodic CSI-RS for CQI reporting (when applicable) relative to SCell activation command for known case; First valid L1-RSRP reporting for the unknown case.
T_{uncertainty_SP} represents the time period between reception of the activation command for semi-persistent CSI-RS resource set for CQI reporting relative to SCell activation command for known case; First valid L1-RSRP reporting for the unknown case.
T_{RRC_delay} represents the RRC procedure delay.

In these cases, the L1-RSRP measurement delay is defined as shown in Table 1 (see TS 38.133 clause 9.5.4.1, Table 9.5.4.1-2), where N=8 UE receive (RX) beams are assumed for SSB based L1-RSRP measurement in FR2. This considers the worst case where the UE has no information about the SCell and hence needs to sweep all DL beams and adjust its receiver (RX) beam setting to ensure the activation.

TABLE 1
Measurement period T_{L1-RSRP}_{_{—}}_{Measurement}_{_{—}}_{Period SSB} for FR2

| Configuration | T_{L1-RSRP}_{_{—}}_{Measurement}_{_{—}}_{Period}_{_{—}}_{SSB} (ms) |
|---|---|
| non-discontinuous | max(T_{Report}, ceil(M*P*N)*T_{SSB}) |
| reception (DRX) | |
| DRX cycle ≤ 320 ms | max(T_{Report}, ceil(1.5*M*P*N)*max(T_{DRX}, |
| | T_{SSB})) |
| DRX cycle > 320 ms | ceil(1.5*M*P*N)*T_{DRX} |

Note:
T_{SSB} = ssb-periodicityServingCell is the periodicity of the SSB-Index configured for L1-RSRP measurement. T_{DRX} is the DRX cycle length. T_{Report} is configured periodicity for reporting.

In Release 18, it is approved in RAN #95e that one of the objectives is to reduce the SCell activation delay in the FR2, although any solution may not be limited to the FR2.

It is observed when activating an FR2 unknown SCell, the activation delay is too long and it is expected to further reduce the activation delay.

Example embodiments of the present disclosure provide a solution for reducing cell activation delay, which is named as “fast cell activation”. Especially, a terminal device may determine at least one measurement result of the SCell at the termin al device, and the terminal device may further perform the layer 1 measurement based on the at least one measurement result. As such, the time length of the activation procedure may be shorter. Thus, the activation delay can be reduced, the power consumption can be reduced, and the communication efficiency may be improved. Principles and some example embodiments of the present disclosure will be described in detail below with reference to the accompanying drawings.

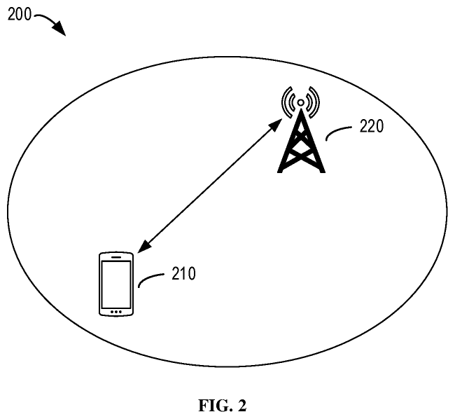

FIG. 2 illustrates an example of a network environment 200 in which some example embodiments of the present disclosure may be implemented. The environment 200, which may be a part of a communication network, comprises a terminal device 210 and a network device 220.

The communication environment 200 may comprise any suitable number of devices and cells. In the communication environment 200, the network device 220 can provide services to the terminal device 210, and the network device 220 and the terminal device 210 may communicate data and control information with each other. In some embodiments, the network device 220 and the terminal device 220 may communicate with direct links/channels. A link from the network device 220 to the terminal device 210 is referred to as a downlink (DL), while a link from the terminal device 210 to the network device 220 is referred to as an uplink (UL). The terminal device 210 can be configured with more than one cell. In some example embodiments, the terminal device 210 can be connected to a primary cell (PCell) and/or a secondary cell under the control of the network device 220.

In the system 100, a link from the network device 220 to the terminal device 210 is referred to as a downlink (DL), while a link from the terminal device 210 to the network device 220 is referred to as an uplink (UL). In downlink, the network device 220 is a transmitting (TX) device (or a transmitter) and the terminal device 210 is a receiving (RX) device (or a receiver). In uplink, the terminal device 210 is a transmitting TX device (or a transmitter) and the network device 220 is a RX device (or a receiver). It is to be understood that the network device 220 may provide one or more serving cells. In some embodiments, the network device 220 can provide multiple cells.

Communications in the network environment 200 may be implemented according to any proper communication protocol(s), comprising, but not limited to, cellular communication protocols of the first generation (1G), the second generation (2G), the third generation (3G), the fourth generation (4G), the fifth generation (5G) and the sixth generation (6G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the numbers of devices (i.e., the terminal device 210 and the network device 220) and their connection relationships and types shown in FIG. 2 are only for the purpose of illustration without suggesting any limitation. For example, the environment 200 may include any suitable numbers of devices adapted for implementing embodiments of the present disclosure. For example, while FIG. 2 depicts the terminal device 210 as a mobile phone, the terminal device 210 may be any type of user equipment.

In the present disclosure, the network device 220 may provide multiple cells including a PCell and a secondary cell. In some embodiments, the secondary cell may be a primary secondary cell (PSCell) or an SCell. For ease of description, the following embodiments will be described with reference to SCell, but it is to be understood that the embodiments may apply to PSCell and will not be repeated.

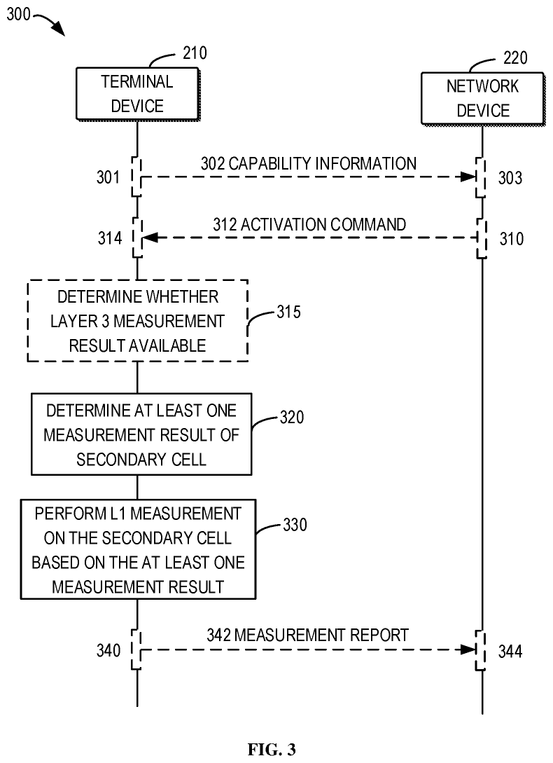

FIG. 3 illustrates an example of a process flow 300 in accordance with some example embodiments of the present disclosure. For the purpose of discussion, the process flow 300 will be described with reference to FIG. 2. The process flow 300 involves a terminal device 210 and a network device 220. It would be appreciated that although the process flow 300 has been described in the network environment 200 of FIG. 2, this process flow may be likewise applied to other communication scenarios.

In some embodiments, the network device 220 may provide multiple cells, including a primary cell and a secondary cell. It is assumed that the terminal device 210 is in the primary cell provided by the network device 220, and the secondary cell is to be activated by an activation procedure. The activation procedure includes a layer 1 measurement phase, which may be a legacy layer 1 measurement or a fast layer 1 measurement. It takes less time for the fast layer 1 measurement than the legacy layer 1 measurement. In some embodiments, the fast layer 1 measurement may also be called as a reduced layer 1 measurement, and the present disclosure does not limit this aspect. In some embodiments, the layer 1 measurement could be a measurement of L1-RSRP and/or layer 1-signal to interference plus noise ratio (L1-SINR), or any of the measurement results of the beam information in a cell.

In some example embodiments, alternatively, as shown in FIG. 3, the terminal device 210 may transmit 301 capability information 302 to the network device 220. In some example embodiments, the capability information 302 may indicate whether the terminal device 210 supports a fast cell activation and/or a reduced layer 1 measurement. In some example embodiments, the capability information 302 may indicate a minimum required number of beams, e.g., a minimum required number of UE RX beams applied, for the reduced layer 1 measurement. The minimum required number may be used to determine the measurement delay for the reduced layer 1 measurement. In some example embodiments, the capability information 302 may indicate a predefined refinement factor. For example, the predefined refinement factor may be denoted as N_{refine}, and the refinement factor may also be called as a compensation factor which is used to mitigate the beam difference between a layer 3 measurement result and a layer 1 measurement result, which will be described in detail below.

On the other side of communication, the network device 220 may receive 303 the capability information 302. As such, the network device 220 may be aware of the capability information 302 of the terminal device 210 and may perform further configurations or indications based on the capability information 302.

In the process flow 300, the network device 220 transmits 310 an activation command 312 to the terminal device 210. The activation command 312 may indicate to activate a secondary cell, for example, the activation command 312 may include an identifier (ID) of the secondary cell. In some embodiments, the activation command 312 may be or may be comprised in an activation message.

In some example embodiments, the activation command 312 may indicate a permission that the terminal device 210 is allowed to perform a fast cell activation and/or a reduced layer 1 measurement during an activation procedure of the secondary cell. In some examples, the activation command 312 may be based on the capability information 302. For example, if the capability information 302 indicates that the terminal device 210 supports a fast cell activation and/or a reduced layer 1 measurement, the activation command 312 may indicate a permission that the terminal device 210 is allowed to perform the fast cell activation and/or the reduced layer 1 measurement. In some examples, the activation command 312 may be based on the network device 220's decision. The present disclosure does not limit this aspect.

In some example embodiments, the activation command 312 may indicate a scaling factor, which can be denoted as K. For example, the activation command 312 may include the scaling factor K. For example, the activation command 312 may include a value (such as N1) to determine the factor scaling, and the value may be 1/K. The scaling factor may be used by the terminal device 210 for determining multiple UE receive-beams used for reduced layer 1 measurement, which will be described below. In some other examples, the activation command 312 may include a number of the multiple receive-beams, denoted as M, and this example may be regarded as an alternatively embodiment of the scaling factor K. The scaling factor and/or the values may also be indicated using other messages from the network device 220 to the terminal device 210.

In some example embodiments, the activation command 312 may indicate spatial information associated with reference signals. The spatial information associated with reference signals may be used by the terminal device 210 for determining multiple receive-beams, which will be described below.

In some example embodiments, the scaling factor or the spatial information in the activation command 312 may be based on the capability information 302. For example, if the capability information 302 indicates a minimum required number of beams for the reduced layer 1 measurement, the network device 220 may determine the scaling factor and/or the spatial information based on the minimum required number of beams for the reduced layer 1 measurement. As such, the requirement of the terminal device 210 may be met.

On the other side of communication, the terminal device 210 receives 314 the activation command 312. The terminal device 210 may further perform the activation procedure of the secondary cell.

In some example embodiments, alternatively, as shown in FIG. 3, the terminal device 210 may determine 315 whether at least one layer 3 measurement result of the secondary cell is available at the terminal device 210. In some example embodiments, the layer 3 measurement result(s) may be determined based on intra-frequency measurement performed in deactivated secondary cell and/or during secondary cell activation. In some example embodiments, the layer 3 measurement result(s) may be determined based on inter-frequency measurement performed before the cell is configured as a secondary cell.

In some example embodiments, the layer 3 measurement result available may be a layer 3 measurement result satisfying some measurement and/or accuracy requirements under measurement conditions, or in some examples, may be called as a valid layer 3 measurement result.

Continuing with reference to FIG. 3, the terminal device 210 determines 320 at least one measurement result of the secondary cell. In some example embodiment, the at least one measurement result is the at least one layer 3 measurement result, if the at least one layer 3 measurement result is available. In some other example embodiments, the at least one measurement result is the measurement result obtained within a cell detection phase, if the at least one layer 3 measurement result is unavailable.

Continuing with reference to FIG. 3, the terminal device 210 performs 330 a layer 1 measurement on the secondary cell based, at least partially, on the at least one measurement result.

Specifically, in some example embodiments, if the at least one layer 3 measurement result of the secondary cell is available at the terminal device 210, the terminal device 210 may perform the layer 1 measurement based on the at least one layer 3 measurement result without a cell detection phase of the activation procedure.

In some example embodiments, the terminal device 210 may determine the activation steps in the activation procedure of the secondary cell based on whether the at least one layer 3 measurement result of the secondary cell is available. Specifically, if the at least one layer 3 measurement result of the secondary cell is available, the cell detection phase may be skipped, and the terminal device 210 may perform the layer 1 measurement without performing the cell detection.

In some embodiments, the measurement may be based on SSBs. It is noted that one SSB consists of a primary synchronization signal (PSS)/secondary synchronization signal (SSS) block and physical broadcast channel (PBCH) block. The cell detection of a terminal device 210 is conducted through two parts. Firstly the terminal device 210 reads PSS blocks to acquire synchronization for symbol boundary and also confirm primary cell ID (PCID) contained in PSS. Secondly, the terminal device 210 reads PBCH block to acquire master information block (MIB) information. If the terminal device 210 succeeds in decoding the PBCH by using cyclic redundancy check (CRC) bits, then the terminal device 210 declares a status of ‘the cell is detected’ for the L3 measurement that measures RX signal strength of the SSB block. In the present disclosure, skipping cell detection may mean that the terminal device 210 only acquires the symbol boundary for further L1 measurement by reading PSS up to UE implementation. It implies that network device 220 does not mandate the terminal device 210 to read PBCH block for SCell activation procedure, since the terminal device 210 is not requested to report cell detection status or L3 measurement. As such, the cell detection phase may be skipped and the communication will not be affected.

In some example embodiments, if the at least one layer 3 measurement result of the secondary cell is available, the terminal device 210 may perform the layer 1 measurement without a cell detection phase. In some examples, the layer 1 measurement performed at the terminal device 210 may be a legacy layer 1 measurement. For example, the layer 1 measurement may refer to those described with reference to Table 1 above. In some other examples, the layer 1 measurement performed at the terminal device 210 may be a reduced layer 1 measurement (a fast layer 1 measurement). In some examples, the time length of the reduced layer 1 measurement is shorter than that of the legacy layer 1 measurement. In some examples, the layer 1 measurement can also be skipped. The terminal device 210 may determine the layer 1 measurement result by applying a compensation factor, e.g., predefined refinement factor, to the layer 3 measurement result of the secondary cell.

In some example embodiments, the terminal device 210 may perform the reduced layer 1 measurement based on one of the conditions: a signal noise ratio (SNR) is not lower than a threshold, capability information has been transmitted to a network device, the capability information indicating whether the terminal device supports the reduced layer 1 measurement, an activation command from the network device indicates a permission that the terminal device is allowed to perform the reduced layer 1 measurement, or an indication that the terminal device is to perform the reduced layer 1 measurement based on a scaling factor or a predefined refinement factor. In some embodiments, if one of the conditions is fulfilled, the terminal device 210 may perform the reduced layer 1 measurement during an activation procedure of the secondary cell.

In some examples, if the terminal device 210 has a capability to perform the reduced layer 1 measurement, for example, the capability information 302 indicates that the terminal device 210 supports the reduced layer 1 measurement, the terminal device 210 may perform the reduced layer 1 measurement. In some examples, if the activation command 312 indicates a permission that the terminal device 210 is allowed to perform a reduced layer 1 measurement, the terminal device 210 may perform the reduced layer 1 measurement. In some examples, if the channel condition is good, for example, the SNR is not lower than a threshold (such as 2 dB), the terminal device 210 may perform the reduced layer 1 measurement.

In some other examples, if the terminal device 210 is not intending performing a legacy layer 1 measurement or the terminal device 210 is able to compensate the potential performance degradation, the terminal device 210 may perform the reduced layer 1 measurement during an activation procedure of the secondary cell.

In some embodiments, the reduced layer 1 measurement (the fast layer 1 measurement) may be performed on at least one beam for the secondary cell. In some examples, the at least one beam may be based on UE RX beams, for example, there are N=8 UE RX beams. In some examples, the at least one beam may be derived from the at least one layer 3 measurement result. In some examples, the number of the at least one beam may be denoted as M.

In some example embodiments, the reduced layer 1 measurement may be performed on multiple beams. In some example, the number of the multiple beams may be based on a number of detectable SSBs based on the at least one layer 3 measurement result. For example, the detectable SSBs may be the SSBs detectable in the latest intra-frequency measurement results in deactivated secondary cell. It is to be understood the term “detectable” may refer to the specification TS 38.133, section 9.2.2 and thus will not be repeated herein.

In some examples, the multiple beams may be based on a number of SSBs associated with a number of measureable CSI-RS resources based on the at least one layer 3 measurement result. For example, the measureable CSI-RS resources may be the CSI-RS resources measurable if CSI-RS based measurement is configured in deactivated secondary cell. It is to be understood the term “measurable” may refer to the specification TS 38.133, section 9.10.2 and thus will not be repeated herein.

In some examples, the number of the multiple beams may be based on a first predefined number of best SSBs based on the at least one layer 3 measurement result. For example, the first predefined number may be denoted as X1, the terminal device 210 may determine X1 best measurement results from the at least one layer 3 measurement result, and the terminal device 210 may further determine the first predefined number of best SSBs corresponding to the X1 best measurement results. In other words, the reduced layer 1 measurement may be performed on X1 best measured SSBs.

In some examples, the number of the multiple beams may be based on a second predefined number of best CSI-RS resources based on the at least one layer 3 measurement result. For example, the first predefined number may be denoted as Y1, the terminal device 210 may determine Y1 best measurement results from the at least one layer 3 measurement result, and the terminal device 210 may further determine the second predefined number of best CSI-RS resources corresponding to the Y1 best measurement results. In other words, the reduced layer 1 measurement may be performed based on Y1 best measured CSI-RS resources.

In some examples, the number of the multiple beams may be based on a number of SSBs in which the at least one layer 3 measurement result is larger than a first threshold. For example, the terminal device 210 may determine, from the at least one layer 3 measurement result, one or more measurement results higher than the first threshold, and the terminal device 210 may further determine the SSBs corresponding to the one or more measurement results. It is assumed that the number of the determined SSBs may be denoted as X2. In other words, the reduced layer 1 measurement may be performed based on X2 measured SSBs higher than a first threshold.

In some examples, the number of the multiple beams may be based on a number of CSI-RS resources in which the at least one layer 3 measurement result is larger than a second threshold. For example, the terminal device 210 may determine, from the at least one layer 3 measurement result, one or more measurement results higher than the second threshold, and the terminal device 210 may further determine the CSI-RS resources corresponding to the one or more measurement results. It is assumed that the number of the determined CSI-RS resources may be denoted as Y2. In other words, the reduced layer 1 measurement may be performed based on Y2 measured CSI-RS resources higher than a first threshold.

In some embodiments, the first predefined number (X1) and the second predefined number (Y1) may be the same number, the first threshold and the second threshold may be a same threshold, and the present disclosure does not limit this aspect.

As such, the reduced layer 1 measurement may be performed on less beams and the activation delay may be reduced. In some embodiments, one SSB or CSI-RS on which the layer 1 measurement is performed may also be called as a measurement sample (or sample). As described, the number of samples for the reduced layer 1 measurement may be denoted as M, which is an integer.

In some example embodiments, the terminal device 210 may determine the multiple beams. For example, the number of the multiple beams (M) is larger than the minimum required number of beams, which is described with reference to capability information 302 above. For example, the number of the multiple beams (M) determined based on a scaling factor (K) included in the activation command. For example, the terminal device 210 may determine that M=N/K, where K is an integer larger than 1, such as K=4. For example, the terminal device 210 may determine the multiple beams based on the spatial information which is associated with source reference signals, such as SSB or CSI-RS.

In some example embodiments, the terminal device 210 may determine the layer 1 measurement result from the at least one layer 3 measurement result. For example, the terminal device 210 may multiply at least one layer 3 measurement result with a predefined refinement factor (denoted by N_{refine}) to obtain the layer 1 measurement result without additional layer 1 measurement. As such, the terminal device 210 may refine the beams for layer 1 measurement based on the beams for layer 3 measurement. In some embodiments, the predefined refinement factor (N_{refine}) may be determined by the terminal device 210 based on the UE implementation. The predefined refinement factor may consider the antenna gain margin between the rough beam and the refined beams at the UE.

In some example embodiments, the reduced layer 1 measurement may be performed on a specific beam, that is, the number of the at least one beam on which the reduced layer 1 measurement is performed may be 1. For example, the specific beam may correspond to an SSB with a best result in the at least one layer 3 measurement result. For example, the beam may correspond to a CSI-RS with a best result in the at least one layer 3 measurement result.

For example, if CSI-RS based L3 measurement is configured on the to-be-activated secondary cell, the reduced layer 1 measurement may be performed on the beam corresponding to the best CSI-RS based measurement result, as CSI-RS based L3 measurement is assumed using the same search engine as the layer 1 measurement. The terminal device 210 may determine the best result in the at least one layer 3 measurement result, and determine the best CSI-RS associated with the best result, for example, the best result is obtained by measuring the best CSI-RS. The terminal device 210 may further determine the beam corresponding to the best CSI-RS, and thus the terminal device 210 may perform the reduced layer 1 measurement on the beam corresponding to the best CSI-RS.

It is to be understood that there may be scenarios where the terminal device 210 will rely on no need for refined layer 1 measurements and instead use layer 3 measurements based on wide beams. In this case there is no need to perform measure layer 1 measurement based on narrow beams to activate an unknown SCell. As such, the activation procedure may be simplified, and the delay may be reduced. By comparing with legacy activation procedure where layer 1 measurement is measured on all reference signals configured for the layer 1 measurement (potential beams), the reduced layer 1 measurement in some embodiments of the present disclosure is now restricted to part of the reference signals, e.g. the best CSI-RS (beam), to accelerate the beam reporting.

As described above, the cell detection phase may be skipped if the at least one layer 3 measurement result is available. In some other example embodiments, if the at least one layer 3 measurement result is unavailable at the terminal device 210, the terminal device 210 may perform the cell detection.

Specifically, in some other example embodiments, if the at least one layer 3 measurement result is unavailable, the terminal device 210 may perform a layer 1 measurement based on the at least one measurement result determined within in the cell detection phase. In some examples, the terminal device 210 may perform the reduced layer 1 measurement and the cell detection in parallel.

In some example embodiments, the terminal device 210 may perform the reduced layer 1 measurement based on one of the conditions: a signal noise ratio (SNR) is not lower than a threshold, capability information has been transmitted to a network device, the capability information indicating whether the terminal device supports a fast cell activation and/or the reduced layer 1 measurement, an activation command from the network device indicates a permission that the terminal device is allowed to perform the fast cell activation and/or the reduced layer 1 measurement, or an indication that the terminal device is to perform the reduced layer 1 measurement based on a predefined refinement factor. In some embodiments, if one of the conditions is fulfilled, the terminal device 210 may perform the fast cell activation and/or reduced layer 1 measurement during an activation procedure of the secondary cell.

In some embodiments, the reduced layer 1 measurement (the fast layer 1 measurement) may be performed on at least one beam for the secondary cell. In some examples, the at least one beam may be based on UE RX beams, for example, there are N=8 UE RX beams. In some examples, the at least one beam may be derived from the at least one layer 3 measurement result. In some examples, the number of the at least one beam may be denoted as M.

In some embodiments, the terminal device 210 may determine the at least one beam based on one or more of: a number of detectable SSBs based on the at least one measurement result, a number of SSBs being associated with a number of measureable CSI-RS resources based on the at least one measurement result, a first predefined number of best measured SSBs based on the at least one measurement result, a second predefined number of best measured CSI-RS resources based on the at least one measurement result, a number of SSBs on which the at least one measurement result being larger than a first threshold, a number of CSI-RS resources on which the at least one measurement result being larger than a second threshold, or a number of beams selected from full beams for the at least one measurement result.

For example, the layer 1 measurement may be performed on multiple beams which are determined based on a number of SSBs detectable in the measurements in the cell detection phase, that is, the multiple beams may be determined based on SSBs detectable in the intra-frequency measurement results during the cell detection. In some examples, the multiple beams may be based on a predefined number of SSBs/CSI-RS resources with best measurements in the cell detection phase. In some examples, the multiple beams may be based on multiple SSBs/CSI-RS resources with the associated measurements in the cell detection phase higher than a threshold.

In some embodiments, the layer 1 measurement result may be based on at least one measurement result obtained within the cell detection phase and/or a predefined refinement factor (N_{refine}). For example, the layer 1 measurement result may be determined by multiplying the at least one measurement result obtained within the cell detection phase with the predefined refinement factor.

It is noted that the measurement object for layer 1 measurement and the measurement in cell detection may not be set in two separate periods. Specifically, the receive beam selection during different measurements by the terminal device 210 is transparent to the network device 220. In other words, the UE RX beam selection behavior remains up to UE implementation.

For example, the measurement in cell detection: 8*Trs, where,
Trs is the SMTC periodicity of the SCell being activated if the terminal device 210 has been provided with an SMTC configuration for the SCell in SCell addition message, otherwise Trs is the SMTC configured in the measObjectNR having the same SSB frequency and subcarrier spacing (SCS).

For example, the layer 1 measurement: N*T_{SSB}, where,
T_{SSB}=ssb-periodicityServingCell is the periodicity of the SSB-Index, where N=8 always for RX beam sweeping.

However, the network device 220 does not demand a report of the measurement in the cell detection phase, therefore the terminal device 210 does not need separate measurement sweepings for layer 1 measurement after cell detection during the SMTC window assigned to SCell. Instead, the terminal device may refine the layer 1 measurement beam using the measurement in the cell detection phase. The same N=8 beam sweeping is not required, instead, a predefined refinement factor (N_{refine}) may be used to determine the layer 1 measurement beams for the secondary cell activation. In some examples, the predefined refinement factor (N_{refine}) is associated with the capability of the terminal device 210, for example, Nrefine<8 and the terminal device 210 may conduct the reduced layer 1 measurement as part of the cell detection using the predefined refinement factor (N_{refine}). In some example, the predefined refinement factor (N_{refine}) may also be called as an L3 based refined Rx setting factor, and the present disclosure does not limit this aspect.

In some other embodiments, the reduced layer 1 measurement may be performed on a specific beam. For example, the specific beam may correspond to an SSB with a best result in the at least one measurement result determined within in the cell detection phase. For example, the specific beam may correspond to a CSI-RS with a best result in the at least one measurement result determined within in the cell detection phase.

As such, the terminal device 210 may perform the SCell activation procedure by skipping the cell detection phase and/or by performing a reduced layer 1 measurement, and thus the time length of the activation procedure may be shorter and the delay may be reduced.

Continuing with reference to FIG. 3, alternatively or in addition, the terminal device 210 may transmit 340 a measurement report 342 to the network device 220. In some example embodiments, the measurement report 342 may indicate a layer 1 measurement result. In some example embodiments, the measurement report 342 may further indicate one or more of: whether the layer 1 measurement result is based on full beams, a number of beams on which the layer 1 measurement result is based, whether a configured SSB or a configured CSI-RS resource is measured, or whether the layer 1 measurement is a reduced (or fast) layer 1 measurement or a legacy layer 1 measurement. In some embodiments, the measurement report 342 may indicate whether the cell activation procedure of the secondary cell is a fast cell activation or a legacy cell activation.

In some examples, the terminal device 210 may report whether the layer 1 measurement is performed on full beams or on a certain smaller number of beams. In some examples, the terminal device 210 may indicate the layer 1 report is based on a reduced layer 1 measurement or a legacy layer 1 measurement. In some examples, for the SSBs or CSI-RS resources configured for layer 1 measurement, the terminal device 210 may indicate whether the configured SSB or CSI-RS resource is measured. For example, a special value in the measurement report may be used to indicate whether a specific SSB or CSI-RS resource is measured.

In some other examples, the measurement report may also indicate that the terminal device 210 is to perform further layer 1 measurement based on the predefined refinement factor. As such, the terminal device 210 may indicate if it will (or needs to) perform further layer 1 measurement (such as a further reduced layer 1 measurement) for possible beam refinement.

Based on the embodiments described with reference to FIG. 3, the cell detection phase may be skipped and/or a reduced layer 1 measurement may be performed during an activation procedure, and thus the time length of the activation procedure may be shorter and the delay may be reduced.

In the present disclosure, the layer 1 measurement may also be called as L1 measurement, L1-RSRP measurement or the like, the present disclosure does not limit this aspect. In some example embodiments, the secondary cell to be activated may be a FR2 unknown SCell.

In the present disclosure, a fast cell activation may refer to a procedure for activating a cell (such as an SCell) by at least one of: without a cell detection phase, with a fast/reduced layer 1 measurement phase, without a layer 1 measurement phase, with a fast/reduced layer 1 measurement within the cell detection phase, or the like.

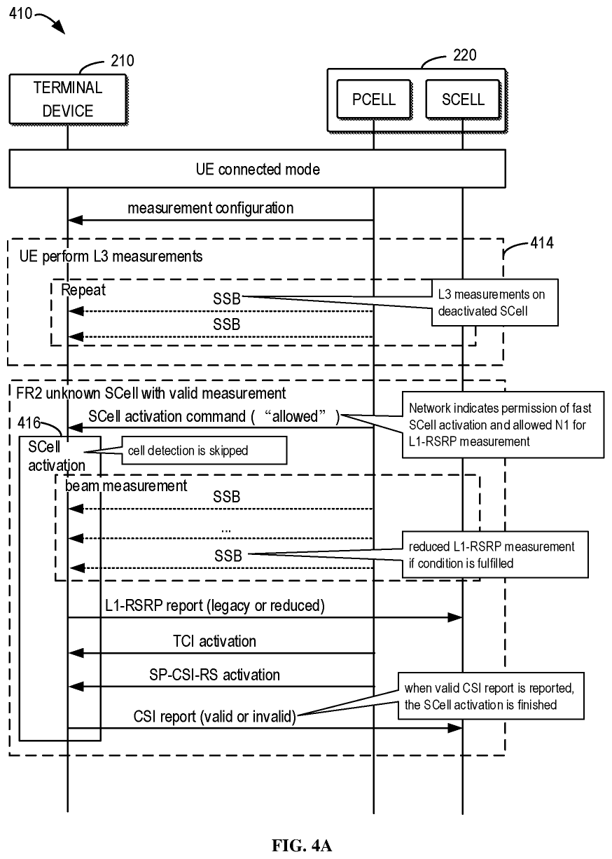

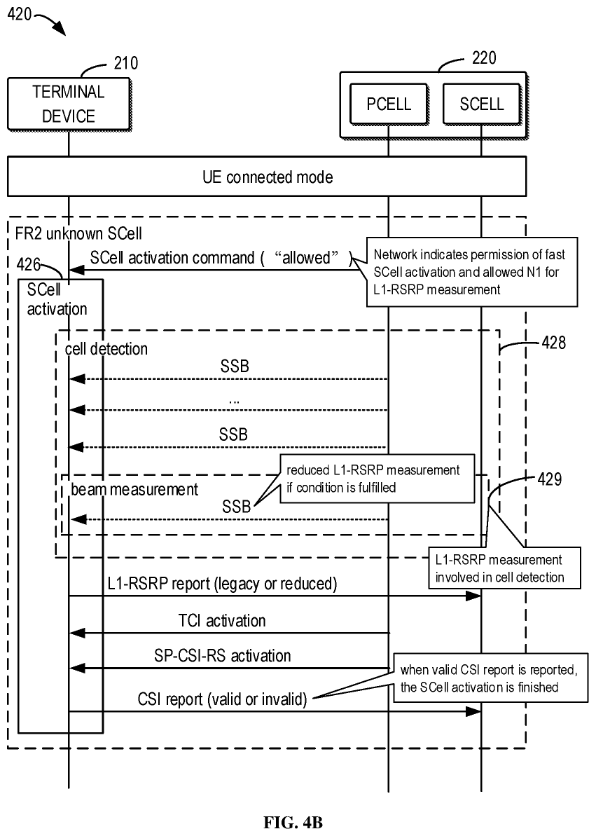

FIG. 4A illustrates an example process 410 where the terminal device has layer 3 measurement results for FR2 unknown SCell in accordance with some example embodiments of the present disclosure. The process 410 relates to a terminal device 210 (UE for example) and a network device 220 providing a PCell and an SCell.

As shown in FIG. 4A, the terminal device 210 is in a connected mode (UE connected mode) and is configured with carrier aggregation including PCell and SCell. The SCell is configured but in a deactivated state. The network device 220 may transmit a measurement configuration to the terminal device 210, and thus the terminal device 210 may perform L3 measurements 414. Specifically, the UE in connected mode may perform an intra-frequency measurement on the deactivated SCell. For example, the L3 measurements may be based on multiple SSBs from the network device 220.

The network device 220 transmits an SCell activation command to the terminal device 210. And accordingly, the terminal device 210 may perform an SCell activation procedure 416. As shown in 416, it is understood that the SCell is an FR2 unknown cell for the network device 220, since no L3 measurement report has been transmitted to the network device 220 after 414. But the terminal device 210 has a valid L3 measurement upon the SCell activation.

In some example embodiments, the network device 220 may indicate permission of reduced L1-RSRP measurement in the SCell activation (fast SCell activation). In some example embodiments, the SCell activation may optionally indicate allowed number of samples (denoted by N1) for L1-RSRP measurement.

During the SCell activation procedure 416, the terminal device 210 finds out it has valid intra-frequency measurement at SCell activation, hence can skip the cell detection and directly perform L1-RSRP measurement. A reduced L1-RSRP measurement is allowed based on available intra-frequency measurements, but the number of samples shall not be below the indicated N1 from the network device 220 if present.

The terminal device 210 sends an L1-RSRP report which may indicate whether the report is based on a reduced or a legacy L1-RSRP measurement. The network device 220 may then configure or activate CSI-RS for channel measurements, TCI activation and SP-CSI-RS activation as shown in FIG. 4A. And the terminal device 210 may send a CSI report to the network device 220, the CSI report indicates the end of the SCell activation.

As such, if the UE has acquired valid intra-frequency measurements in deactivated SCell, the UE is allowed to skip the cell detection upon SCell activation and directly perform L1-RSRP measurements based on available intra-frequency measurements.

FIG. 4B illustrates an example process 420 where the terminal device does not have a layer 3 measurement result for FR2 unknown SCell in accordance with some example embodiments of the present disclosure. The process 420 relates to a terminal device 210 (UE for example) and a network device 220 providing a PCell and an SCell.

As shown in FIG. 4B, the terminal device 210 is in a connected mode (UE connected mode). The network device 220 may transmit a measurement configuration to the terminal device 210, but the terminal device 210 has not performed the L3 measurements or has not acquired valid L3 measurement result.

The network device 220 transmits an SCell activation command to the terminal device 210. And accordingly, the terminal device 210 may perform an SCell activation procedure 426. In some example embodiments, the network device 220 may indicate permission of reduced L1-RSRP measurement in the SCell activation (fast SCell activation). In some example embodiments, the SCell activation may optionally indicate allowed number of samples (denoted by N1) for L1-RSRP measurement.

As shown in 426, it is understood that the SCell is an FR2 unknown cell for the network device 220. During the SCell activation procedure 426, the terminal device 210 needs to first detect the SCell while the L1-RSRP measurement 429 can be performed within or in parallel with the cell detection 428, since there is no valid L3 measurement result.

The terminal device 210 sends an L1-RSRP report which may indicate whether the report is based on a reduced or a legacy L1-RSRP measurement. The network device 220 may then configure or activate CSI-RS for channel measurements, TCI activation and SP-CSI-RS activation as shown in FIG. 4B. And the terminal device 210 may send a CSI report to the network device 220, the CSI report indicates the end of the SCell activation.

Alternatively, the terminal device 210 may indicate its capability of supporting a parallel L1-RSRP measurement (i.e., a reduced L1 measurement) within the cell detection phase. In the end, the SCell activation delay can be reduced by removing L1-RSRP measurement delay.

As such, if the terminal device does not have any valid layer 3 measurements at the time of SCell activation, it is allowed to perform L1-RSRP measurement based on the measurements in cell detection phase.

In many scenarios, the terminal device (such as a UE) may have been measuring the deactivated SCell recently as UE is required to perform intra-frequency measurement as specified in TS 38.133 clause 9.2.5. At the time of activation, the UE has likely acquired a valid intra-frequency measurement result based on SSB and/or CSI-RS resources in the to-be-activated SCell, although is not able to send the reporting as the UE may not be allowed to transmit in deactivated SCell. Therefore, the SCell activation in FR2 unknown SCell may be discussed separately.

In some cases, when the SCell is initially configured and activated, there could be two cases: (1) If the UE has been configured with inter-frequency measurements on the SCell, the UE has acquired the L3 measurement results on the target SCell hence the SCell is detected. (2) If the UE has not measured the target SCell, it would have to start from cell detection and perform L1-RSRP from the scratch as currently specified in FR2 unknown condition. The very long activation delay is needed only in this very specific case (2).

In other cases, if the SCell has been activated and becomes deactivated, when the SCell is again activated, the UE has been required to perform intra-frequency measurement in the deactivated SCell. As the measurement is based on meascycleSCell, the SCell can be maintained detected and well measured so that the cell detection is not needed in activation.

| | |
|---|---|
| measCycleSCell | ENUMERATED {sf160, sf256, sf320, sf512, sf640, |
| | sf1024, sf1280} |
| OPTIONAL | -- Need R |

It is observed when activating an FR2 unknown SCell, the cell detection and L1-RSRP measurements are not always mandatorily needed. The activation steps can be further refined considering the measurements available at the UE hence to optimize the activation delay.

The above various embodiments of the present disclosure may have partial impact to the current specification. For example, the current specification TS 38.133 in RAN4 and TS 38.3311 in RAN 2 may be updated (underlined) as follows in view of the above various embodiments of the present disclosure.

If the PCell/PSCell and the target SCell are configured as FR1-FR2 CA or if the PCell/PSCell and the target SCell are in a FR2 band pair with independent beam management, and the target SCell is unknown to UE and semi-persistent CSI-RS is used for CSI reporting, provided that the side condition Ês/Iot≥−2 dB is fulfilled, then T_{activation_time} is:
6 ms+T_{L1-RSRP, measure}+T_{L1-RSRP, report}+T_{HARQ}+max(T_{uncertainty_MAC}+T_{FineTiming}+2 ms, T_{uncertainty_SP}), if the UE supports the fast activation capability and has a valid measurement of the SCell being activated;
6 ms+T_{FirstSSB_MAX}+15*T_{SMTC_MAX}+8*Tᵣₛ+T_{L1-RSRP, report}+T_{HARQ}+max(T_{uncertainty_MAC}+T_{FineTiming}+2 ms, T_{uncertainty_SP}), if the UE supports the fast activation capability and does not have a valid measurement of the SCell being activated;
6 ms+T_{FirstSSB_MAX}+15*T_{SMTC_MAX}+8*Tᵣₛ+T_{L1-RSRP, measure}+T_{L1-RSRP, report} T_{HARQ}+max(T_{uncertainty_MAC}+T_{FineTiming}+2 ms, T_{uncertainty_SP}), otherwise.

If the PCell/PSCell and the target SCell are configured as FR1-FR2 CA or if the +PCell/PSCell and the target SCell are in a FR2 band pair with independent beam management, and the target SCell is unknown to UE and periodic CSI-RS is used for CSI reporting, provided that the side condition Ês/Iot≥−2 dB is fulfilled, then T_{activation_time} is:
3 ms+T_{L1-RSRP, measure}+T_{L1-RSRP, report}+max {(T_{HARQ}+T_{uncertainty_MAC}+5 ms+T_{FineTiming}), (T_{uncertainty_RRC}+T_{RRC_delay})}, if the UE supports the fast activation capability and has a valid measurement of the SCell being activated.
3 ms+T_{FirstSSB_MAX}+15*T_{SMTC_MAX}+8*Tᵣₛ+T_{L1-RSRP, measure}+T_{L1-RSRP, report}+max {(T_{HARQ}+T_{uncertainty_MAC}+5 ms+T_{FineTiming}), (T_{uncertainty_RRC}+T_{RRC_delay})}, if the UE supports the fast activation capability and does not have a valid measurement of the SCell being activated.
3 ms+T_{FirstSSB_MAX}+15*T_{SMTC_MAX}+8*Tᵣₛ+T_{L1-RSRP, measure}+T_{L1-RSRP, report}+max {(T_{HARQ}+T_{uncertainty_MAC}+5 ms+T_{FineTiming}), (T_{uncertainty_RRC}+T_{RRC_delay})}, otherwise.
   where
   T_{L1-RSRP, measure} is L1-RSRP measurement delay T_{L1-RSRP_Measurement_Period_SSB} ms or T_{L1-RSRP_Measurement_Period_CSI-RS} based on applicability as defined in clause 9.5 assuming M=1. If the UE supports the reduced activation capability and has a valid measurement of the SCell being activated, a scaling factor N_{refine} can be applied to reduce the L1-RSRP measurement delay T_{L1-RSRP_Measurement_Period_SSB} ms or T_{L1-RSRP_Measurement_Period_CSI-RS}.

TABLE 9.5.4.1-2
Measurement period T_{L1-RSRP}_{_{—}}_{Measurement}_{_{—}}_{Period}_{_{—}}_{SSB} for FR2

| Configuration | T_{L1-RSRP}_{_{—}}_{Measurement}_{_{—}}_{Period}_{_{—}}_{SSB} (ms) |
|---|---|
| non-DRX | max(T_{Report}, ceil(M*P*N_{refine}) *T_{SSB}) |
| DRX cycle ≤ 320 ms | max(T_{Report}, ceil(1.5*M*P* N_{refine})*max(T_{DRX}, |
| | T_{SSB})) |
| DRX cycle > 320 ms | ceil(1.5*M*P* N_{refine})*T_{DRX} |

Note:
T_{SSB} = ssb-periodicityServingCell is the periodicity of the SSB-Index configured for L1-RSRP measurement. T_{DRX} is the DRX cycle length. T_{Report} is configured periodicity for reporting.

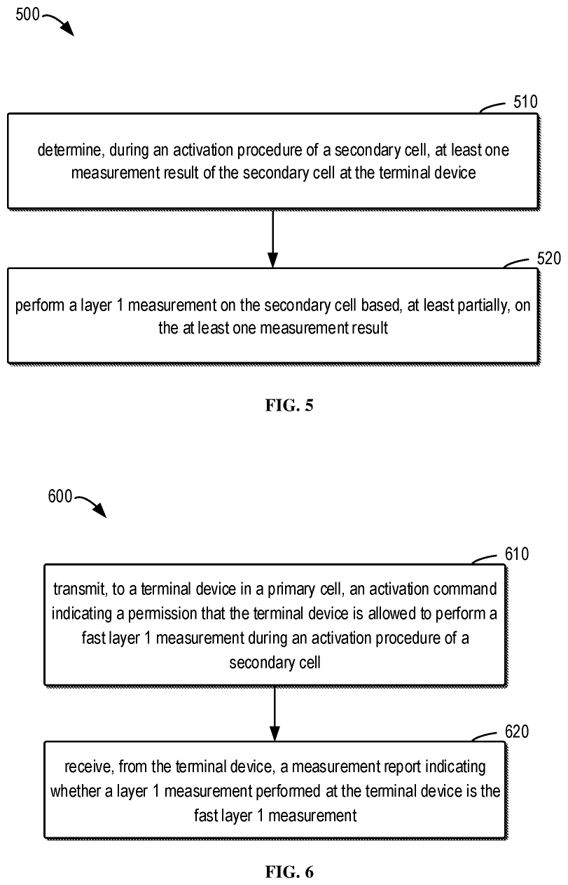

FIG. 5 illustrates a flowchart 500 of a method implemented at a terminal device in accordance with some example embodiments of the present disclosure. For the purpose of discussion, the method 500 will be described from the perspective of the terminal device 210 with reference to FIG. 2.

At block 510, the terminal device 210 determines, during an activation procedure of a secondary cell, at least one measurement result of the secondary cell at the terminal device. At block 520, the terminal device 210 performs a layer 1 measurement on the secondary cell based, at least partially, on the at least one measurement result.

In some example embodiments, the terminal device 210 determines, during an activation procedure of a secondary cell, whether at least one layer 3 measurement result is available for the secondary cell. The terminal device 210 determines that the at least one measurement result is the at least one layer 3 measurement result if the at least one layer 3measurement result is available. The terminal device 210 performs the layer 1 measurement on the secondary cell based, at least partially, on the at least one measurement result without a cell detection phase of the activation procedure.

In some example embodiments, the terminal device 210 determines, during an activation procedure of a secondary cell, whether at least one layer 3 measurement result is available for the secondary cell. The terminal device 210 determines that the at least one measurement result within a cell detection phase of the activation procedure if the at least one layer 3measurement result is unavailable. The terminal device 210 performs the layer 1 measurement on the secondary cell based, at least partially, on the at least one measurement result within the cell detection phase of the activation procedure.

In some example embodiments, the terminal device 210 performs a fast layer 1 measurement on at least one beam for the secondary cell.

In some example embodiments, the terminal device 210 determines the at least one beam based on one or more of: a number of detectable SSBs based on the at least one measurement result, a number of SSBs being associated with a number of measureable CSI-RS resources based on the at least one measurement result, a first predefined number of best measured SSBs based on the at least one measurement result, a second predefined number of best measured CSI-RS resources based on the at least one measurement result, a number of SSBs on which the at least one measurement result being larger than a first threshold, a number of CSI-RS resources on which the at least one measurement result being larger than a second threshold, or a number of beams selected from full beams for the at least one measurement result.

In some example embodiments, the terminal device 210 receives, from a network device, at least one of spatial information associated with a reference signal or a scaling factor, for determining the at least one beam.

In some example embodiments, at least one of the spatial information or the scaling factor is received in an activation command for the activation procedure.

In some example embodiments, the terminal device 210 performs the fast layer 1 measurement on a beam corresponding to an SSB with a best result in the at least one measurement result.

In some example embodiments, the terminal device 210 performs a fast layer 1 measurement based on the at least one measurement result and a predefined refinement factor.

In some example embodiments, the terminal device 210 performs the fast layer 1 measurement based on at least one of the following conditions: a signal noise ratio is not lower than a threshold, capability information has been transmitted to a network device, the capability information indicating whether the terminal device supports the fast layer 1 measurement, an activation command from the network device indicates a permission that the terminal device is allowed to perform the fast layer 1 measurement, or an indication that the terminal device is to perform the fast layer 1 measurement based on a predefined refinement factor.

In some example embodiments, the terminal device 210 transmits capability information to a network device, the capability information indicating at least one of: whether the terminal device supports the fast layer 1 measurement, the predefined refinement factor, or a minimum required number of beams for the fast layer 1 measurement.

In some example embodiments, the terminal device 210 transmits a measurement report to a network device, the measurement report indicating at least one of: a layer 1 measurement result on the secondary cell, whether the layer 1 measurement result is based on full beams, a number of beams on which the layer 1 measurement result is based, whether a configured SSB or a configured CSI-RS resource is measured, or whether the layer 1 measurement is a fast layer 1 measurement.

FIG. 6 illustrates a flowchart 600 of a method implemented at a network device in accordance with some example embodiments of the present disclosure. For the purpose of discussion, the method 600 will be described from the perspective of the network device 220 with reference to FIG. 2.

At block 610, the network device 220 transmits to a terminal device in a primary cell, an activation command indicating a permission that the terminal device is allowed to perform a fast activation and/or a fast layer 1 measurement during an activation procedure of a secondary cell. At block 620, the network device 220 receives, from the terminal device, a measurement report indicating whether a layer 1 measurement performed at the terminal device is the fast layer 1 measurement.

In some example embodiments, the measurement report further indicates at least one of: a layer 1 measurement result on the secondary cell, whether the layer 1 measurement result is based on full beams, a number of beams on which the layer 1 measurement result based, or whether a configured SSB or a configured CSI-RS resource is measured.

In some example embodiments, the network device 220 receives capability information from the terminal device, the capability information indicating at least one of: whether the terminal device supports the fast layer 1 measurement, a predefined refinement factor, or a minimum required number of beams for the fast layer 1 measurement.

In some example embodiments, the activation command further comprises at least one of: spatial information associated with reference signals for the terminal device to determine at least one beam for the fast layer 1 measurement, or a scaling factor for the terminal device to determine the at least one beam for the fast layer 1 measurement.

In some example embodiments, an apparatus capable of performing the method 500 (for example, the terminal device 210) may comprise means for performing the respective steps of the method 500. The means may be implemented in any suitable form. For example, the means may be implemented in a circuitry or software module.

In some example embodiments, the apparatus comprises: means for determining, at a terminal device during an activation procedure of a secondary cell, at least one measurement result of the secondary cell at the terminal device; and means for performing a layer 1 measurement on the secondary cell based, at least partially, on the at least one measurement result.

In some example embodiments, the apparatus further comprises: means for determining whether at least one layer 3 measurement result is available for the secondary cell. The means for determining at least one measurement result of the secondary cell comprises: means for determining that the at least one measurement result is the at least one layer 3 measurement result if the at least one layer 3measurement result is available. The means for performing the layer 1 measurement on the secondary cell comprises: means for performing the layer 1 measurement based, at least partially, on the at least one measurement result without a cell detection phase of the activation procedure.

In some example embodiments, the apparatus further comprises: means for determining whether at least one layer 3 measurement result is available for the secondary cell. The means for determining at least one measurement result of the secondary cell comprises: means for determining that the at least one measurement result within a cell detection phase of the activation procedure if the at least one layer 3measurement result is unavailable. The means for performing the layer 1 measurement on the secondary cell comprises: means for performing the layer 1 measurement based, at least partially, on the at least one measurement result within the cell detection phase of the activation procedure.

In some example embodiments, the means for performing a layer 1 measurement comprises: means for performing a fast layer 1 measurement on at least one beam for the secondary cell.

In some example embodiments, the apparatus further comprises: means for determining the at least one beam based on at least one of: a number of detectable SSBs based on the at least one measurement result, a number of SSBs being associated with a number of measureable CSI-RS resources based on the at least one measurement result, a first predefined number of best measured SSBs based on the at least one measurement result, a second predefined number of best measured CSI-RS resources based on the at least one measurement result, a number of SSBs on which the at least one measurement result being larger than a first threshold, a number of CSI-RS resources on which the at least one measurement result being larger than a second threshold, or a number of beams selected from full beams for the at least one measurement result.

In some example embodiments, the apparatus further comprises: means for receiving, from a network device, at least one of spatial information associated with a reference signal or a scaling factor, for determining the at least one beam.

In some example embodiments, the at least one of the spatial information or the scaling factor is received in an activation command for the activation procedure.

In some example embodiments, the means for performing the layer 1 measurement result comprises: means for performing the fast layer 1 measurement on a beam corresponding to an SSB with a best result in the at least one measurement result.

In some example embodiments, the means for performing the layer 1 measurement result comprises: means for performing the layer 1 measurement based on at least one measurement result and a predefined refinement factor.

In some example embodiments, the means for performing the fast layer 1 measurement result comprises: means for performing the fast layer 1 measurement based on at least one of the following conditions: a signal noise ratio is not lower than a threshold, capability information has been transmitted to a network device, the capability information indicating whether the terminal device supports the fast layer 1 measurement, an activation command from the network device indicates a permission that the terminal device is allowed to perform the fast layer 1 measurement, or an indication that the terminal device is to perform the fast layer 1 measurement based on a predefined refinement factor.

In some example embodiments, the apparatus further comprises: means for transmitting capability information to a network device, the capability information indicating at least one of: whether the terminal device supports the fast layer 1 measurement, the predefined refinement factor, or a minimum required number of beams for the fast layer 1 measurement.

In some example embodiments, the apparatus further comprises: means for transmitting a measurement report to a network device, the measurement report indicating at least one of: a layer 1 measurement result on the secondary cell, whether the layer 1 measurement result is based on full beams, a number of beams on which the layer 1 measurement result is based, whether a configured SSB or a configured CSI-RS resource is measured, or whether the layer 1 measurement is a fast layer 1 measurement.

In some example embodiments, an apparatus capable of performing the method 600 (for example, the network device 220) may comprise means for performing the respective steps of the method 600. The means may be implemented in any suitable form. For example, the means may be implemented in a circuitry or software module.

In some example embodiments, the apparatus comprises: transmitting, at a network device to a terminal device in a primary cell, an activation command indicating a permission that the terminal device is allowed to perform a fast layer 1 measurement during an activation procedure of a secondary cell; and means for receiving, from the terminal device, a measurement report indicating whether a layer 1 measurement performed at the terminal device is the fast layer 1 measurement.

In some example embodiments, the measurement report further indicates at least one of: a layer 1 measurement result on the secondary cell, whether the layer 1 measurement result is based on full beams, a number of beams on which the layer 1 measurement result based, or whether a configured synchronization signal block (SSB) or a configured channel state information reference signal (CSI-RS) resource is measured.

In some example embodiments, the apparatus further comprises: means for receiving capability information from the terminal device, the capability information indicating at least one of: whether the terminal device supports the fast layer 1 measurement, a predefined refinement factor, or a minimum required number of beams for the fast layer 1 measurement.

In some example embodiments, the activation command further comprises at least one of: spatial information associated with reference signals for the terminal device to determine at least one beam for the fast layer 1 measurement, or a scaling factor for the terminal device to determine at least one beam for the fast layer 1 measurement.

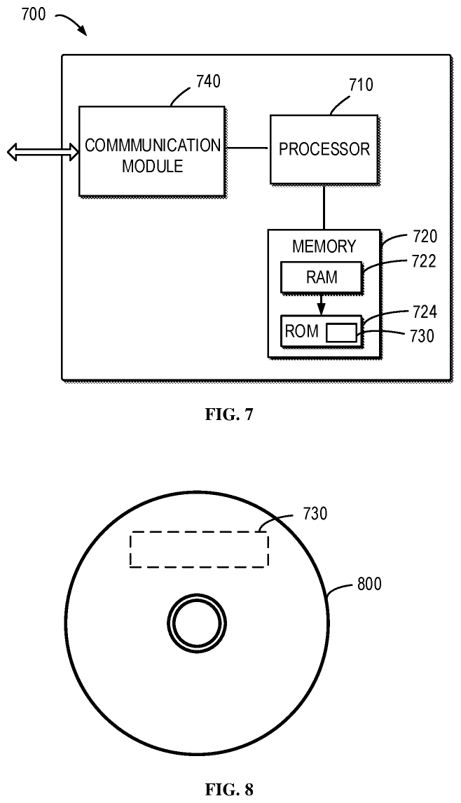

FIG. 7 illustrates a simplified block diagram of a device 700 that is suitable for implementing some example embodiments of the present disclosure. The device 700 may be provided to implement the communication device, for example the terminal device 210, or the network device 220 as shown in FIG. 2. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 3-6. The embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like.

FIG. 8 illustrates a block diagram of an example of a computer readable medium 800 in accordance with some example embodiments of the present disclosure. The computer readable medium 800 has the program 730 stored thereon. It is noted that although the computer readable medium 800 is depicted in form of CD or DVD in FIG. 8, the computer readable medium 800 may be in any other form suitable for carry or hold the program 730.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to any of FIGS. 5-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-39. (canceled)

40. A terminal device comprising:
at least one processor; and
at least one memory storing instructions that, when executed by the at least one processor, cause the terminal device at least to:
determine, during an activation procedure of a secondary cell, at least one measurement result of the secondary cell at the terminal device; and
determine a measurement delay for a layer 1 measurement on the secondary cell based, at least partially, on the at least one measurement result,
wherein the at least one measurement result comprises at least one layer 3 measurement result.

41. The terminal device of claim 40, wherein the at least one memory storing instructions that, when executed by the at least one processor, cause the terminal device at least to:
determine whether at least one layer 3 measurement result is available for the secondary cell;
based on a determination that the at least one layer 3 measurement result is available, determine that the at least one measurement result being the at least one layer 3 measurement result; and
perform the layer 1 measurement on the secondary cell based, at least partially, on the at least one measurement result without a cell detection phase of the activation procedure.

42. The terminal device of claim 40, wherein the at least one memory storing instructions that, when executed by the at least one processor, cause the terminal device at least to:
determine whether at least one layer 3 measurement result is available for the secondary cell;
based on a determination that the at least one layer 3 measurement result is unavailable, determine the at least one measurement result within a cell detection phase of the activation procedure; and
perform the layer 1 measurement on the secondary cell based, at least partially, on the at least one measurement result within the cell detection phase of the activation procedure.

43. The terminal device of claim 40, wherein the at least one memory storing instructions that, when executed by the at least one processor, cause the terminal device at least to perform the layer 1 measurement by:
performing a fast layer 1 measurement on at least one beam for the secondary cell.

44. The terminal device of claim 43, wherein the at least one memory storing instructions that, when executed by the at least one processor, cause the terminal device at least to determine the at least one beam based on at least one of:
a number of detectable synchronization signal blocks, SSBs, based on the at least one measurement result,
a number of SSBs being associated with a number of measurable channel state information reference signal, CSI-RS, resources based on the at least one measurement result,
a first predefined number of best measured SSBs based on the at least one measurement result,
a second predefined number of best measured CSI-RS resources based on the at least one measurement result,
a number of SSBs on which the at least one measurement result being larger than a first threshold,
a number of CSI-RS resources on which the at least one measurement result being larger than a second threshold, or
a number of beams selected from full beams for the at least one measurement result.

45. The terminal device of claim 44, wherein the at least one memory storing instructions that, when executed by the at least one processor, cause the terminal device at least to:
receive, from a network device, at least one of spatial information associated with a reference signal or a scaling factor, for determining the at least one beam.

46. The terminal device of claim 45, wherein the at least one of the spatial information or the scaling factor is received in an activation command for the activation procedure.

47. The terminal device of claim 43, wherein the at least one memory storing instructions that, when executed by the at least one processor, cause the terminal device at least to perform the fast layer 1 measurement result by:
performing the fast layer 1 measurement on a beam corresponding to an SSB with a best result in the at least one measurement result.

48. The terminal device of claim 40, wherein the at least one memory storing instructions that, when executed by the at least one processor, cause the terminal device at least to perform the layer 1 measurement by:
perform a fast layer 1 measurement based on the at least one measurement result and a predefined refinement factor.

49. The terminal device of claim 43, wherein the at least one memory storing instructions that, when executed by the at least one processor, cause the terminal device at least to perform the fast layer 1 measurement based on at least one of the following conditions:
a signal noise ratio is not lower than a threshold,
capability information has been transmitted to a network device, the capability information indicating whether the terminal device supports the fast layer 1 measurement,
an activation command from the network device indicates a permission that the terminal device is allowed to perform the fast layer 1 measurement, or
an indication that the terminal device is to perform the fast layer 1 measurement based on a predefined refinement factor.

50. The terminal device of claim 49, wherein the at least one memory storing instructions that, when executed by the at least one processor, cause the terminal device at least to transmit capability information to a network device, the capability information indicating at least one of:
whether the terminal device supports the fast layer 1 measurement,
the predefined refinement factor, or
a minimum required number of beams for the fast layer 1 measurement.

51. The terminal device of claim 40, wherein the at least one memory storing instructions that, when executed by the at least one processor, cause the terminal device at least to transmit a measurement report to a network device, the measurement report indicating at least one of:
a layer 1 measurement result on the secondary cell,
whether the layer 1 measurement result is based on full beams,
a number of beams on which the layer 1 measurement result is based,
whether a configured SSB or a configured CSI-RS resource is measured, or
whether the layer 1 measurement is a fast layer 1 measurement.

52. A method comprising:
determining, at a terminal device during an activation procedure of a secondary cell, at least one measurement result of the secondary cell at the terminal device; and
determine a measurement delay for a layer 1 measurement on the secondary cell based, at least partially, on the at least one measurement result,
wherein the at least one measurement result comprises at least one layer 3 measurement result.

53. The method of claim 52, further comprising:
determining whether at least one layer 3 measurement result is available for the secondary cell;
wherein determining at least one measurement result of the secondary cell comprises: based on a determination that the at least one layer 3 measurement result is available, determining that the at least one measurement result being the at least one layer 3 measurement result; and
wherein performing the layer 1 measurement comprises: performing the layer 1 measurement on the secondary cell based, at least partially, on the at least one measurement result without a cell detection phase of the activation procedure.

54. The method of claim 52, further comprising:
determining whether at least one layer 3 measurement result is available for the secondary cell;
wherein determining that at least one measurement result of the secondary cell comprises: based on a determination that the at least one layer 3 measurement result is unavailable, determining the at least one measurement result within a cell detection phase of the activation procedure; and
wherein performing the layer 1 measurement comprises: performing the layer 1 measurement on the secondary cell based, at least partially, on the at least one measurement result within the cell detection phase of the activation procedure.

55. The method of claim 52, wherein performing the layer 1 measurement comprises:
performing a fast layer 1 measurement on at least one beam for the secondary cell.

56. The method of claim 55, wherein performing the fast layer 1 measurement result comprises: performing the fast layer 1 measurement based on at least one of the following conditions:
a signal noise ratio is not lower than a threshold,
capability information has been transmitted to a network device, the capability information indicating whether the terminal device supports the fast layer 1 measurement,
an activation command from the network device indicates a permission that the terminal device is allowed to perform the fast layer 1 measurement, or
an indication that the terminal device is to perform the fast layer 1 measurement based on a predefined refinement factor.

57. The method of claim 56, further comprising:
transmitting capability information to a network device, the capability information indicating at least one of:
whether the terminal device supports the fast layer 1 measurement,
the predefined refinement factor, or
a minimum required number of beams for the fast layer 1 measurement.

58. The method of claim 52, further comprising:
transmitting a measurement report to a network device, the measurement report indicating at least one of:
a layer 1 measurement result on the secondary cell,
whether the layer 1 measurement result is based on full beams,
a number of beams on which the layer 1 measurement result is based,
whether a configured SSB or a configured CSI-RS resource is measured, or
whether the layer 1 measurement is a fast layer 1 measurement.

59. A network device comprising:
at least one processor; and
at least one memory storing instructions that, when executed by the at least one processor, cause the network device at least to:
transmit, to a terminal device in a primary cell, an activation command indicating a permission that the terminal device is allowed to perform a fast layer 1 measurement during an activation procedure of a secondary cell; and
receive, from the terminal device, a layer 1 measurement report of a layer 1 measurement indicating, based on a measurement delay, whether the layer 1 measurement performed at the terminal device is the fast layer 1 measurement,
wherein the layer 1 measurement report is based, at least partially, on at least one layer 3 measurement result.
